(19) United States
(12) Patent Application Publication
(10) Pub. No.: US 2026/0049227 A1
(43) Pub. Date: Feb. 19, 2026

(54) RADIATION CURABLE VINYL PRIMER SYSTEM AND INK-RECEPTIVE COATINGS FORMED THEREFROM

(71) Applicant: SWIMC LLC, Cleveland, OH (US)

(72) Inventors: Daiwen CHEN, Oak Ridge, NC (US); Brad WINKLE, Jamestown, NC (US); Jigarkumar PATEL, Greensboro, NC (US)

(21) Appl. No.: 18/802,036

(22) Filed: Aug. 13, 2024

Related U.S. Application Data
(60) Provisional application No. 63/534,391, filed on Aug. 24, 2023.

(51) Int. Cl. C09D 11/54; B41M 5/00; B41M 7/00; C09D 11/101; C09D 11/107

(52) U.S. Cl. CPC C09D 11/54; B41M 5/0047; B41M 7/0045; C09D 11/101; C09D 11/107

(57) ABSTRACT

A vinyl primer system is provided. The system includes a first oligomer and a photoinitiator. The first oligomer includes at least one of a polyether (meth)acrylate or modified polyether (meth)acrylate. The photoinitiator is configured to cure at least the first oligomer upon exposure to UV light, LED light, and/or electron beam. The first oligomer is present in an amount of from 5% to 90% by weight of the vinyl primer system. The vinyl primer system contains less than 20% by weight of monofunctional (meth)acrylic-based monomers. The vinyl primer system is configured to provide an ink-receptive coating on a substrate.

### CROSS-REFERENCE TO RELATED APPLICATIONS

The present application is related to, and claims priority to, U.S. Provisional Application Ser. No. 63/534,391, filed Aug. 24, 2023, pending, the entire contents of which are incorporated herein by reference.

### TECHNICAL FIELD

The present invention relates to a vinyl primer system and methods of making the same to provide an ink-receptive coating for a substrate, the ink-receptive coating including a photoinitiator and a first oligomer comprising a polyether (meth)acrylate or modified polyether (meth)acrylate.

### BACKGROUND OF THE INVENTION

Vinyl-based flooring is becoming increasingly popular as an alternative to natural hardwood floors due to its durability, cost, ease-of-installation, and engineered, predictable design. Several materials are used in each vinyl-based floor panel such that the installed flooring is sound absorbing, durable yet comfortable to walk on, and aesthetically pleasing. For example, a vinyl-based floor panel may comprise a base substrate, several structural layers, as well as adhesive, decorative, protective, and UV-blocking coatings.

### SUMMARY OF THE INVENTION

One object of the present invention is to provide a vinyl primer system that is radiation curable and ink-receptive (or printable) and that can be used in particular in the SPC (stone plastic composite core) and LVT (luxury vinyl tile) flooring industries.

A further object of the present invention is to provide a vinyl primer system that provides one or more of improved adhesion to substrates, improved intercoat adhesion with digital inks over the top surface, and good print quality.

Another object of the present invention is to provide a vinyl primer system that is radiation curable, preferably UV curable, and can be applied in an environmentally friendly manner in production of flooring products.

An additional object of the present invention is to provide a system and methods for applying the vinyl primer system to a substrate.

These and other objects of this invention, alone or in combination, have been satisfied by the discovery of a vinyl primer system comprising a first oligomer comprising at least one of a polyether (meth)acrylate or modified polyether (meth)acrylate; and a photoinitiator configured to cure at least the first oligomer upon exposure to UV light, LED light, and/or electron beam, wherein the first oligomer is present in an amount of from 5 to 90% by weight of the vinyl primer system, and the vinyl primer system contains less than 20% by weight of monofunctional (meth)acrylic-based monomers; and wherein the vinyl primer system is configured to provide an ink-receptive coating on a substrate, along with methods for its application to a substrate.. The vinyl primer system, ink-receptive coating made therefrom, and methods for applying will be further described in the following detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a cross-sectional view of some embodiments of a coatings system arranged over a substrate and comprising an ink-receptive primer coating as will be discussed further herein.

FIGS. 2-9 illustrate perspective views of some embodiments of a method of forming a coatings system over a substrate and curing the coatings system over the substrate using a curing radiation.

FIG. 10 illustrates a flow diagram of some embodiments of a method that may correspond to the method illustrated in FIGS. 2-9.

### DETAILED DESCRIPTION OF THE INVENTION

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an”additive means that the coating composition can include “one or more”additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,”“second,”etc., are used to distinguish one element from another.

The term “comprises” and variations thereof do not have a limiting meaning where these terms appear in the description and claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The term “acrylic” as used herein includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

The term “aliphatic” when used in the context of a carbon-carbon double bond includes both linear (or open chain) aliphatic carbon-carbon double bonds and cycloaliphatic carbon-carbon double bonds but excludes aromatic carbon-carbon double bonds of aromatic rings.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, and the like.

The term “(co)polymer” as used herein includes both homopolymers (polymers containing units from a single monomer) and copolymers (polymers containing units from two or more different monomers), unless otherwise specifically stated.

The term “cross-linker” as used herein refers to a molecule capable of forming a covalent linkage between polymers or between two different regions of the same polymer.

The term “glass transition temperature” or “Tg” in the present invention can be measured by various conventional techniques including, for example, differential scanning calorimetry (“DSC”) or calculation by using a Fox equation. DSC data and methods described herein are in accordance with ASTM D6604-00.

The term “on,” when used in the context of a coating applied on a substrate, includes both coatings applied directly or indirectly to the substrate. Thus, for example, a coating applied to a primer layer overlying a substrate constitutes a coating applied on the substrate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

The term “vinyl polymer” refers to a polymer prepared by addition polymerizing an ethylenically unsaturated component (e.g., a mixture of ethylenically unsaturated monomers and/or oligomers).

In accordance with an embodiment of the present invention, a vinyl primer system is provided. The vinyl primer system includes a first oligomer and a photoinitiator. The first oligomer includes at least one of a polyether (meth)acrylate or a modified polyether (meth)acrylate, and the first oligomer is present in an amount of from 5% to 90% by weight of the vinyl primer system. The vinyl primer system contains less than 20% by weight of monofunctional (meth)acrylic-based monomers. The photoinitiator is configured to cure at least the first oligomer upon exposure to UV light, LED light, and/or electron beam. The vinyl primer system is configured to provide an ink-receptive coating on a substrate.

In accordance with an embodiment of the present invention, a system is provided that includes an ink-receptive primer coating, an ink coating arranged over the ink-receptive primer coating, and optionally one or more additional coatings arranged over the ink coating. At least one of the ink-receptive primer coating or a first additional coating of the one or more additional coatings comprises a vinyl primer system. The vinyl primer system includes a photoinitiator and a first oligomer comprising at least one of polyether (meth)acrylate or modified polyether (meth)acrylate. The vinyl primer system contains 10 to 95% by weight of a combination of the first oligomer and any additional polymerizable or cross-linkable compounds if present. The system is configured to be arranged over a substrate.

In accordance with an embodiment of the present invention, a method of coating a substrate is provided. The method includes applying a primer composition on a substrate; applying a digital ink to the primer composition; applying one or more additional coatings to the substrate and over the primer composition and digital ink; and exposing the primer composition, the digital ink, and the one or more additional coatings to a curing radiation to form a cured coating system over the substrate. At least one of the primer system or a first additional coating of the one or more additional coatings includes a photoinitiator and a first oligomer, the first oligomer comprising at least one of polyether (meth)acrylate or modified polyether (meth)acrylate.

Embodiments of the invention disclosed herein relate to a vinyl primer system. The vinyl primer system comprises a first oligomer and a photoinitiator. The first oligomer comprises polyether (meth)acrylate or modified polyether (meth)acrylate. In some embodiments, the vinyl primer system is applied to a substrate, and the coated substrate may be used for flooring, wall coverings, countertops, and other building material applications. The vinyl primer system may be applied to the substrate by roll coating, spray coating, or some other suitable application method. After application to the substrate, the photoinitiator in the vinyl primer system is configured to cure at least the first oligomer upon exposure to a curing radiation such as UV light, LED light, electron beam, a combination thereof, or some other suitable radiation. The photoinitiator comprises at least one free radical.

Upon curing, the vinyl primer system provides an ink-receptive coating arranged over a substrate. The ink-receptive coating is configured to adhere to and protect the substrate and is also configured to receive and adhere to an overlying ink coating without compromising the quality of the ink coating. Thus, the ink-receptive coating formed from the vinyl primer system may prevent or mitigate the ink coating from peeling away from the substrate, from bleeding into the vinyl primer system, from overspreading on the substrate, and the like. The ink coating may be applied to the ink-receptive coating via printing to achieve a desired, intricate design over the substrate. For example, in the flooring industry, ink coatings may be printed onto synthetic substrates to mimic natural materials such as wood, stone, and the like. In some other applications, ink coatings may be printed onto substrates to achieve some artistic design such as painted faux stone for flooring, backsplash, countertops, or some other suitable application. In some embodiments, several ink coatings may be applied to the substrate to distribute various pigments and/or amounts thereof for the desired aesthetics. Similarly, multiple layers of the ink-receptive coating may be used over the substrate as needed for primer and/or adhesion purposes.

In the vinyl primer system, the first oligomer is present in an amount of from about, for example, preferably 5% to 90% by weight, more preferably 10% to 90% by weight, even more preferably 20% to 80% by weight, and most preferably 30% to 70% by weight. Thus, in some embodiments, vinyl primer system is a single resin system comprising the first oligomer. The first oligomer can have different degrees of functionality, such as di-, tri-, or tetra-functionality. The first oligomer has acrylate functionality that may be uniform or that may vary over the length of the oligomer chain. In some other embodiments, the vinyl primer system comprises the first oligomer and optionally, an additional polymerizable or cross-linkable compound. Thus, in some embodiments, the vinyl primer system contains about, for example, preferably 10% to 95%, more preferably 30% to 95%, even more preferably 50% to 95%, and most preferably 70% to 90% by weight of a combination of the first oligomer and any additional polymerizable or cross-linkable compound (if present). The additional polymerizable or cross-linkable compound may comprise one or more monomers, a second oligomer, or a combination thereof.

For example, in some embodiments, the additional polymerizable or cross-linkable compound is a second oligomer. The second oligomer may assist with achieving the desired cure speed, pigment wetting, and other properties. The second oligomer is present in an amount from preferably less than 40%, more preferably less than 30%, even more preferably less than 20%, and most preferably less than 10% by weight of the vinyl primer system. When there is too much of the second oligomer in the vinyl primer system, then the quality of an ink coating printed onto the ink-receptive coating is poor. When the vinyl primer system comprises the first oligomer and a second oligomer, the first and second oligomers are together present from about preferably 10% to about 95%, more preferably 10% to 95%, still more preferably 30% to 95%, even more preferably 50% to 95%, and most preferably 70% to 90% by weight of the vinyl primer system. In some embodiments, the second oligomer may comprise an epoxy (meth)acrylate, a polyester (meth)acrylate, or a urethane (meth)acrylate. The second oligomer may have different degrees of functionality, preferably of two or higher.

In some embodiments, the polymerizable or cross-linkable compound comprises one or more monomers, which may be mono-, di-, or tri-functional acrylated monomers or more preferably, di-or tri-functional acrylated monomers. To preserve the print quality of ink coatings on the ink-receptive coating, the vinyl primer system may contain preferably less than 20%, more preferably less than 18%, even more preferably less than 16%, even more preferably less than 14%, even more preferably less than 12%, and most preferably less than 10% by weight of monofunctional (meth)acrylic-based monomers.

The vinyl primer system may further comprise other additives such as pigments, fillers, diluents, extenders, wetting agents, leveling agents, dispersing agents, anti-settling agents, defoamers, rheology modifiers, and the like to achieve desired properties such as viscosity, wetting, cure speed, adhesion, aesthetics, film thickness, and like. Each optional ingredient is preferably included in a sufficient amount to serve its intended purpose, but not in such an amount to adversely affect the vinyl primer system or the ink-receptive coating resulting therefrom. In some embodiments, the vinyl primer system comprises about, for example, preferably 0% to 50%, more preferably 1% to about 35%, even more preferably 1% about 25%, and most preferably 5% to 15% by weight of pigment. In some embodiments, the vinyl primer system comprises about, for example, preferably 0% to 50%, more preferably 1% about 35%, even more preferably 0% to 12%, and most preferably 5% to 15% by weight of an extender. The desired viscosity of the vinyl primer system prior to application to the substrate may be, for example, between 200 and 1500 centipoise at 77 degrees Celsius, as measured in accordance with ASTM D 2196-86. The viscosity measurement may also be performed according to some other suitable viscosity test method. In some embodiments, one or more layers of the ink-receptive coating may be arranged over a substrate.

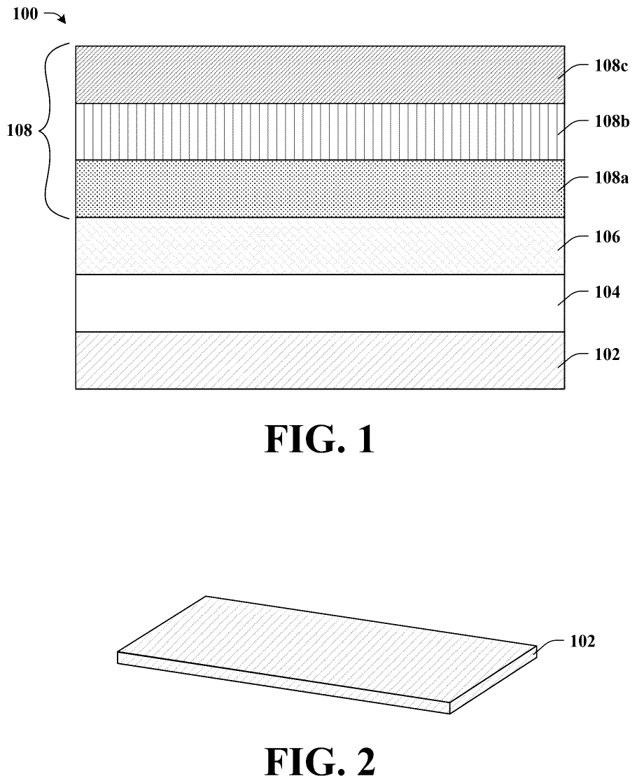

Turning now to FIG. 1, some embodiments of a system 100 comprising various coatings over a substrate will be described. The system 100 may comprise the ink-receptive coating 104 arranged over a substrate 102. The ink-receptive coating 104, which comprises the vinyl primer system disclosed herein, is arranged over the substrate 102. In some embodiments, the ink-receptive coating 104 is arranged directly on the substrate 102 and functions as a primer to adhere to the substrate 102 and receive an overlying layer. For example, the system 100 further comprises an ink coating 106 arranged over the ink-receptive coating 104. The ink coating 106 may comprise several layers. When cured, each layer of the ink-receptive coating 104 may have a dry film thickness in a range of between, for example, preferably 3 micrometers to 40 micrometers, more preferably 5 micrometers to 30 micrometers, and most preferably 10 micrometers to 20 micrometers. In some embodiments, each layer of the ink-receptive coating 104 is sanded after curing and before application of another coat. In some such embodiments, the aforementioned values of the dry film thickness of each layer of the ink-receptive coating 104 is the dry film thickness before sanding.

Further, the system 100 may optionally comprise one or more additional coatings 108 arranged over the substrate 102. In some embodiments, the one or more additional coatings 108 may comprise, for example, a first layer 108a arranged over the ink coating 106; a second layer 108b arranged over the first layer 108a; and a third layer 108c arranged over the second layer 108b. These additional coatings 108 may be a sealing layer, a protective wear layer, a UV-protection layer, an adhesive layer and/or some other suitable layer. In some embodiments, at least one of the additional coatings 108 comprises the vinyl primer system, and thus, may comprise the same composition as the ink-receptive coating 104. When the vinyl primer system is applied over the ink coating 106, the vinyl primer system may aid with adhesion between the ink coating 106 and any additional overlying layers (e.g., 108a-c). Thus, in some embodiments, the system 100 may comprise one or more layers of the ink-receptive coating 104 arranged below the ink coating 106 and also may comprise one or more layers of the ink-receptive coating 104 arranged over the ink coating 106. Alternatively, the system 100 may comprise one or more layers of an ink-receptive coating 104 of a different type than the present invention, with one or more layers of the vinyl primer layer composition of the present invention being arranged over the ink coating as an intercoat adhesion layer. Thus, each layer of the ink-receptive coating 104 in the system 100 may function as a primer layer, an ink-receptive layer, and/or an intercoat adhesion layer. The ink-receptive coating 104 arranged over the ink coating 106 may directly contact the ink coating 106 or may be spaced apart from the ink coating 106 by intervening additional coating layers. It will be appreciated that in some embodiments, more or less than three additional coatings 108 may be arranged over the ink-receptive coating 104.

FIGS. 2-8 illustrate some embodiments of a method of applying an ink-receptive coating to a substrate.

As shown in FIG. 2, a substrate 102 is provided. In some embodiments, the substrate 102 may comprise, for example, engineered wood, a polymer composite, synthetic vinyl, fiberglass, particle board, metal, paper, or combinations thereof. It will be appreciated that the substrate 102 may comprise a series of layers and materials; for example, in some embodiments, the substrate 102 may comprise layers of resin, wood fibers, and fiberglass. In some embodiments, the substrate 102 may be cleaned or pre-treated prior to applying any coatings on the substrate 102. For example, the substrate 102 may be cleaned with acetone or may be sanded prior to applying a coating.

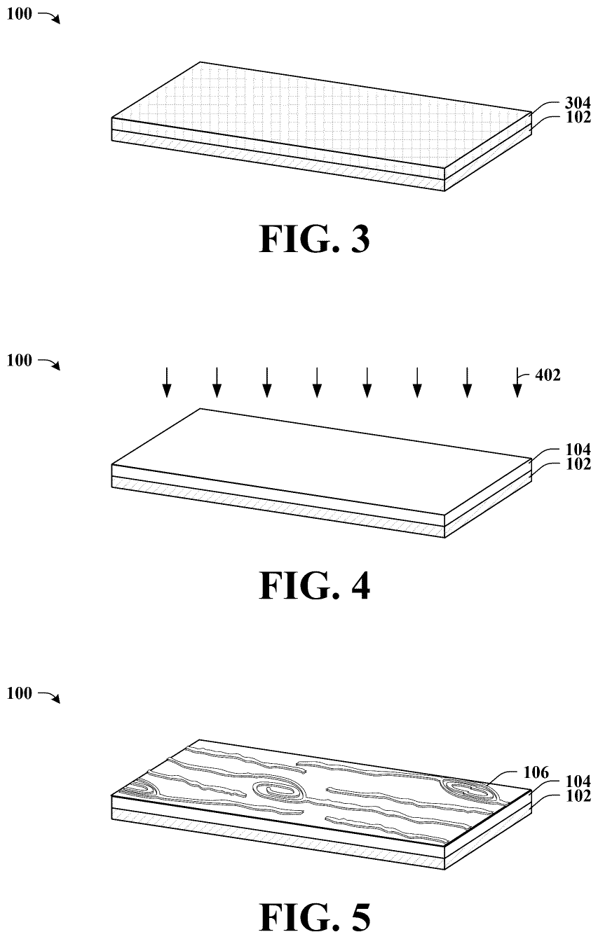

As shown in FIG. 3, primer composition 304, which comprises the vinyl primer system, is formed over the substrate 102. The primer composition 304 may be applied to the substrate 102 by way of spraying, roll-coating, or some other suitable application process. In some embodiments, the substrate 102 may be arranged on a conveyer belt and continuously coated with the primer composition 304 as the substrate 102 is exposed to a coatings application apparatus. In some such embodiments, the substrate 102 may travel through the coatings application apparatus at a rate of between, for example, about 10 feet per minute and about 120 feet per minute. In some embodiments, the amount of primer composition 304 applied to the substrate 102 may be between, for example, about 0.6 grams per square foot and about 2.0 grams per square foot.

As shown in FIG. 4, the primer composition (304 of FIG. 3) is exposed to a curing radiation 402 thereby forming an ink-receptive coating 104 over the substrate 102. The ink-receptive coating 104 may be partially cured or fully cured when initially exposed to the curing radiation 402. In some embodiments, the primer composition (304 of FIG. 3) is exposed to the curing radiation 402 immediately after the application of the primer composition (304 of FIG. 3) in the same process line. In some other embodiments, the primer composition (304 of FIG. 3) is exposed to the curing radiation 402 in a different process line and/or after other layers are formed over the primer composition (304 of FIG. 3). For example, in some such other embodiments, the method may proceed from FIG. 3 to FIG. 5, thereby skipping the steps of FIG. 4.

The curing radiation 402 shown in FIG. 4 may be any desired curing radiation, including, but not limited to, UV light, LED light, electron beam, or combinations thereof. The curing radiation 402 is configured to activate the photoinitiator to begin cross-linking the first oligomer and any additional polymerizable or cross-linkable compound in the vinyl primer system. Thus, in some embodiments, the photoinitiator is selected based on the available curing radiation and/or the polymerizable components of the vinyl primer system. Alternatively, the curing radiation may be selected based on the photoinitiator and/or the polymerizable components of the vinyl primer system. In some embodiments, before additional coatings are applied to the ink-receptive coating 104, the ink-receptive coating 104 is only partially cured. Such partial curing allows the ink-receptive coating 104 to better receive and adhere to overlying layers, which also mitigates peeling. Additionally, with the partial curing, the system can still be handled during manufacturing and/or storage without damaging the ink-receptive coating 104 and/or substrate 102. The ink-receptive coating 104 may then be fully cured in later manufacturing steps. In some other embodiments, before additional coatings are applied to the ink-receptive coating 104, the ink-receptive coating 104 is fully cured. In some such embodiments, the fully cured ink-receptive coating 104 may be even less prone to damage during manufacturing and/or storage when compared to a partially cured ink-receptive coating 104. In some embodiments, adhesion may be tested using ASTM D3359.

In some embodiments, the curing radiation 402 may comprise various types of UV light. For example, the curing radiation 402 may use UVA light, UVB light, UVC light, and/or UVV light. UVC light has the shortest wavelength with the highest energy, while UVV has the longest wavelength with the lowest energy. In some embodiments, the UV light may be projected onto the ink-receptive coating 104 using a mercury lamp. As an example, the curing radiation 402 may emit at least one of the following curing power settings: UVA light in a range of between 180 mW/m² and 605 mW/m²; UVB light in a range of between 155 mW/m² and 595 mW/m²; UVC light in a range of between 50 mW/m² and 195 mW/m²; UVV light at a power in a range of between 170 mW/m² and 595 mW/m²; or combinations thereof. The intensity of the mercury lamp, the distance between the mercury lamp and the ink-receptive coating 104, the thickness of the ink-receptive coating 104, and the length of time that the ink-receptive coating 104 is exposed to the UV light are among the various parameters that influence the stage of curing of the ink-receptive coating 104. As an example, the ink-receptive coating 104 may be cured to a partial or full cure level when the mercury lamps are set to an intensity between about 25% and about 50%; when the mercury lamps are raised between about 3 and 5 inches above the standard cure height setting; and when the substrates 102 are traveling below the mercury lamps at a rate of between about 10 and 65 feet per minute. It will be appreciated that other parameters and radiation sources may be used to cure the ink-receptive coating 104 to the sufficient partial or full cure level for suitable adhesion to the substrate 102 and overlying layers.

In some embodiments, several layers of the ink-receptive coating 104 may be applied to the substrate 102. In some such embodiments, the ink-receptive coating 104 may optionally be sanded between coats. If sanded between coats, the ink-receptive coating 104 is partially cured before sanding. The ink-receptive coating 104 may also be sanded before any other additional coatings are applied over it.

As shown in FIG. 5, an ink coating 106 may be formed over the ink-receptive coating 104. The ink coating 106 may comprise various pigments. Further, the ink coating 106 may be applied to the substrate 102 using a printer, such as an ink-jet printer, to achieve a specific, digital design. For example, a faux wood grain pattern is illustrated in FIG. 5, which may be used in flooring or cabinet applications. In some embodiments, the ink coating 106 has a surface tension in a range of between, for example, about 20 mN/m and about 28 mN/m. The surface tension of the ink coating 106 influences the composition and the curing stage of the underlying ink-receptive coating 104. For example, in some embodiments, the amount of extender that is in the vinyl primer system may be adjusted for favorable intercoat adhesion between the ink-receptive coating 104 and the ink coating 106.

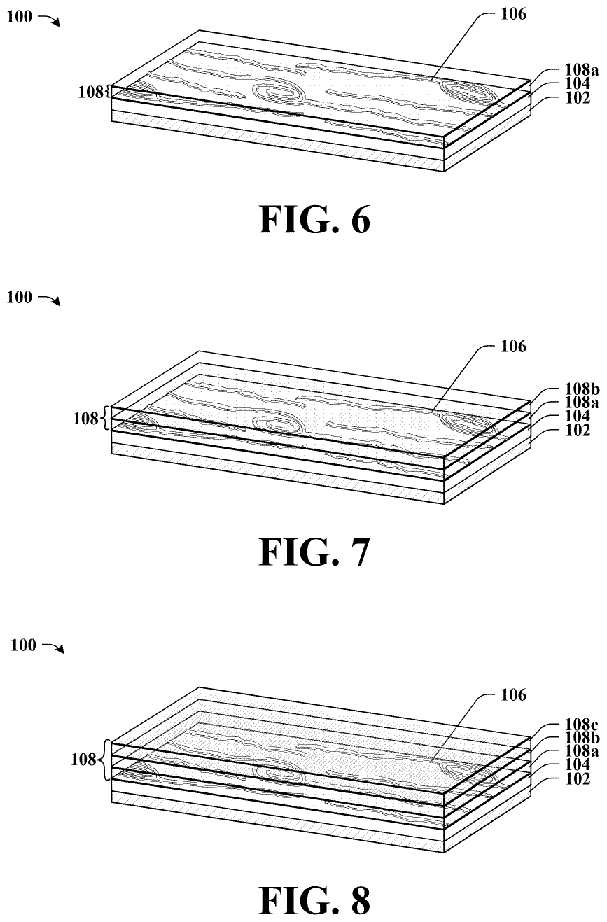

As shown in FIG. 6, the first layer 108a of the one or more additional coatings 108 is applied over the ink coating 106. As shown in FIG. 7, the second layer 108b of the one or more additional coatings 108 is applied over the first layer 108a. As shown in FIG. 8, the third layer 108c of the one or more additional coatings 108 is applied over the second layer 108b. Each of the one or more additional coatings 108 may be applied using various application. Further, each one of the one or more additional coatings 108 may be cured (or partially cured) immediately after application using various curing techniques. The one or more additional coatings 108 are optional, and thus, in some embodiments, the method may proceed from FIG. 5 to FIG. 9, thereby skipping the steps in FIGS. 6-8.

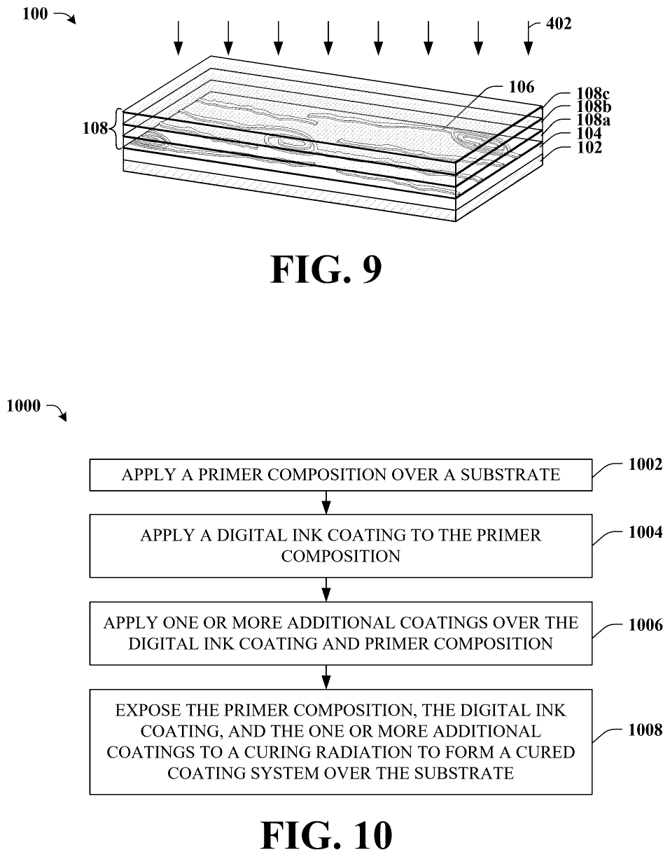

As shown in FIG. 9, in some embodiments, the system 100 may again be exposed to the curing radiation 402 to cure one or more layers in the system 100 arranged over the substrate 102. In some embodiments, the curing radiation 402 of FIG. 9 may be the same as the curing radiation 402 of FIG. 4, while in other embodiments, the curing radiation 402 of FIG. 9 may have different settings and/or be a different type of radiation than the curing radiation 402 of FIG. 4. In embodiments wherein the curing radiation 402 of FIG. 4 was not used, the curing radiation 402 of FIG. 9 may be the first time the ink-receptive coating 104 is cured in the system 100. Upon curing, the system 100 may be durable for future handling, packaging, transport, and installation. In some other embodiments, the system 100 may already be cured and thus, the method may not include the steps shown in FIG. 9.

FIG. 10 illustrates a flow diagram 1000 of some embodiments of a method of applying an ink coating to an ink-receptive coating. In some embodiments, the steps in the flow diagram 1000 of FIG. 10 correspond to the method illustrated in FIGS. 2-9.

At step 1002, a primer composition is applied to a substrate.

At step 1004, a digital ink coating is applied to the primer composition.

At step 1006, one or more additional coatings are applied over the digital ink coating and the primer composition.

At step 1008, the primer composition, the digital ink coating, and the one or more additional coatings are exposed to a curing radiation to form a cured coating system over the substrate.

The following examples are provided to illustrate the present invention and its advantages but should not be construed as limiting a scope of the invention.

The vinyl primer system comprises a first oligomer, which comprises at least one of a polyether (meth)acrylate or modified polyether (meth)acrylate. Thus, in some embodiments, the first oligomer comprises both a polyether (meth)acrylate and a modified polyether (meth)acrylate. Non-limiting examples of the first oligomer include an amine modified polyether acrylate.

In some embodiments, the vinyl primer system comprises one or more additional oligomers. In some such embodiments, the second oligomer may comprise a di-functional epoxy acrylate, trifunctional polyester acrylate, polyester acrylate, trifunctional polyurethane acrylate, aliphatic polyester urethane acrylate, a combination thereof, or some other suitable monomer. In some embodiments, the epoxy acrylate oligomer is preferred for its cure speed.

In some embodiments, the vinyl primer system comprises an additional polymerizable or cross-linkable compound, which may include one or more monomers. In some such embodiments, the one or more monomers may comprise n-butyl methacrylate copolymer, a di-functional acrylate monomer, a combination thereof, or some other suitable monomer. In some embodiments, the monomers are added as a diluent.

In some embodiments, the vinyl primer system comprises various additives. Non-limiting examples of various additives are as follows: an anti-settling agent, a dispersing and wetting agent, micronized extender, a filler such as calcium carbonate, an adhesion promoter such as trifunctional acid ester or polybutadiene homopolymer, an acrylic flow agent, and a hardening agent such as sucrose benzoate resin. In some embodiments, the trifunctional acid ester is preferred for its favorable adhesion to both the substrate and the ink coating. In some embodiments, the extenders increased the surface roughness of the ink-receptive coating to promote adhesion without affecting the quality of the ink coating.

In some embodiments, the vinyl primer system is dispersed in a solvent and is solventborne. In some other embodiments, the vinyl primer system is dispersed in water (e.g., is waterborne) and/or a mixture of water and solvents (e.g., is aqueous). Non-limiting examples of suitable organic solvents for use in the water-based and/or solvent-based coating compositions of the present invention include aliphatic hydrocarbons (e.g., mineral spirits, kerosene, VM&P NAPHTHA solvent, and the like); aromatic hydrocarbons (e.g., benzene, toluene, xylene, the SOLVENT NAPHTHA 100, 150, 200 products and the like); alcohols (e.g., ethanol, n-propanol, isopropanol, n-butanol, iso-butanol and the like); ketones (e.g., acetone, 2-butanone, cyclohexanone, methyl aryl ketones, ethyl aryl ketones, methyl isoamyl ketones, and the like); esters (e.g., ethyl acetate, butyl acetate and the like); glycols (e.g., butyl glycol); glycol ethers (e.g., ethylene glycol monomethyl ether, ethylene glycol monoethyl ether, ethylene glycol monobutyl ether, propylene glycol monomethyl ether, and the like); glycol ether esters (e.g., butyl glycol acetate, methoxypropyl acetate and the like); and mixtures thereof.

The following are non-limiting examples of some embodiments of the present invention:

Embodiment 1. A vinyl primer system comprising:
a first oligomer comprising at least one of a polyether (meth)acrylate or modified polyether (meth)acrylate; and
a photoinitiator configured to cure at least the first oligomer upon exposure to UV light, LED light, and/or electron beam,
wherein the first oligomer is present in an amount of from 5 to 90% by weight of the vinyl primer system, and the vinyl primer system contains less than 20% by weight of monofunctional (meth)acrylic-based monomers; and
wherein the vinyl primer system is configured to provide an ink-receptive coating on a substrate.

Embodiment 2. The vinyl primer system of Embodiment 1, further comprising:

a polymerizable or cross-linkable compound comprising one or more monomers, a second oligomer, or a combination thereof.

Embodiment 3. The vinyl primer system of Embodiment 2, wherein the polymerizable or cross-linkable compound is the second oligomer, wherein the second oligomer is an epoxy (meth)acrylate, a polyester (meth)acrylate, a urethane (meth)acrylate, or combinations thereof.

Embodiment 4. The vinyl primer system of Embodiment 3, wherein the second oligomer is present in the vinyl primer system in an amount less than 40% by weight.

Embodiment 5. The vinyl primer system of one of Embodiments 2 to 4, wherein the polymerizable or cross-linkable compound is the second oligomer, wherein the second oligomer has different degrees of functionality of two or higher.

Embodiment 6. The vinyl primer system of any one of Embodiments 1 to 5, wherein the first oligomer has acrylate functionality which may be uniform or vary along the oligomer chain, and wherein the first oligomer has degrees of functionality of two or more.

Embodiment 7. The vinyl primer system of any one of Embodiments 1 to 6, wherein the ink-receptive coating is configured to have a thickness between 3 and 40 micrometers.

Embodiment 8. The vinyl primer system of any one of Embodiments 1 to 7, wherein the vinyl primer system contains 10 to 95% by weight of the combination of the first oligomer and any additional polymerizable or cross-linkable compounds if present.

Embodiment 9. The vinyl primer system of any one of Embodiments 1 to 8, further comprising 1 to 50% by weight of pigment.

Embodiment 10. The vinyl primer system of any one of Embodiments 1 to 9, further comprising 1 to 35% by weight of an extender.

Embodiment 11. The vinyl primer system of any one of Embodiments 1 to 10, further comprising additives such as defoamers, leveling agents, dispersing agents, anti-settling agents, and/or rheology modifiers.

Embodiment 12. The vinyl primer system of any one of Embodiments 1 to 11, wherein the viscosity of the vinyl primer system is between 200 and 1500 centipoise at 77 degrees Celsius.

Embodiment 13. A system comprising:
an ink-receptive primer coating;
an ink coating arranged over the ink-receptive primer coating; and
optionally one or more additional coatings arranged over the ink coating,
wherein at least one of the ink-receptive primer coating or a first additional coating of the one or more additional coatings comprises a vinyl primer system, the vinyl primer system comprising:
   a first oligomer comprising at least one of polyether (meth)acrylate or modified polyether (meth)acrylate; and
   a photoinitiator configured to cure at least the first oligomer upon exposure to a curing radiation,
wherein the vinyl primer system contains 10 to 95% by weight of a combination of the first oligomer and any additional polymerizable or cross-linkable compounds if present, and
wherein the system is configured to be arranged over a substrate.

Embodiment 14. The system of Embodiment 13, wherein the curing radiation is UV light, LED light, electron beam, or a combination thereof.

Embodiment 15. The system of any one of Embodiments 13 or 14, wherein the ink-receptive primer coating comprises one or more layers, and wherein each layer of the ink-receptive primer coating has a dry film thickness of 3 to 40 micrometers.

Embodiment 16. The system of any one of Embodiments 13 to 15, wherein the ink-receptive primer coating comprises at least one additional oligomer different than the first oligomer.

Embodiment 17. The system of any one of Embodiments 13 to 16, wherein the substrate is a synthetic vinyl floor, engineered wood, polymer composite, metal, wood, paper, or combinations thereof.

Embodiment 18. The system of any one of Embodiments 13 to 17, wherein the ink-receptive primer coating comprises a monomer diluent.

Embodiment 19. A method of coating a substrate comprising:
applying a primer composition on the substrate;
applying a digital ink to the primer composition;
optionally applying one or more additional coatings to the substrate and over the primer composition and digital ink; and
exposing the primer composition, the digital ink, and the one or more additional coatings to a curing radiation to form a cured coating system over the substrate,
wherein at least one of the primer composition or a first additional coating of the one or more additional coatings comprises:
   a first oligomer comprising at least one of polyether (meth)acrylate or modified polyether (meth)acrylate; and
   a photoinitiator.

Embodiment 20. The method of Embodiment 19, wherein the primer composition comprises from 5 to 95% by weight of the first oligomer before curing.

Embodiment 21. The method of one of Embodiments 19 or 20, wherein the primer composition contains 5 to 98% by weight of a combination of the first oligomer and any additional polymerizable or cross-linkable compounds if present.

Embodiment 22. The method of any one of Embodiments 19 to 21, wherein the primer composition is applied via roll coating or spraying.

Embodiment 23. The method of any one of Embodiments 19 to 22, wherein the at least one of the additional coatings and the primer composition both comprise the first oligomer and the photoinitiator.

Embodiment 24. The method of any one of Embodiments 19 to 23, wherein the curing radiation is UV light, LED light, electron beam, or combinations thereof.

Embodiment 25. The method of any one of Embodiments 19 to 24, wherein the at least one of the primer composition or the first additional coating contains less than 20% by weight of monofunctional (meth)acrylic-based monomers.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

While the embodiments discussed herein have been related to the coatings and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several implementations, such feature may be combined with one or more other features of the other implementations as may be desired and advantageous for any given or particular application.

Additional modifications and variations of the present invention are possible in light of the above teachings. It is therefore to be understood that within the scope of the appended claims, the invention may be practiced otherwise than as specifically described herein.

What is claimed is:

1. A vinyl primer system comprising:
a first oligomer comprising at least one of a polyether (meth)acrylate or modified polyether (meth)acrylate; and
a photoinitiator configured to cure at least the first oligomer upon exposure to UV light, LED light, and/or electron beam,
wherein the first oligomer is present in an amount of from 5 to 90% by weight of the vinyl primer system, and the vinyl primer system contains less than 20% by weight of monofunctional (meth)acrylic-based monomers; and
wherein the vinyl primer system is configured to provide an ink-receptive coating on a substrate.

2. The vinyl primer system of claim 1, further comprising:
a polymerizable or cross-linkable compound comprising one or more monomers, a second oligomer, or a combination thereof.

3. The vinyl primer system of claim 2, wherein the polymerizable or cross-linkable compound is the second oligomer, wherein the second oligomer is an epoxy (meth)acrylate, a polyester (meth)acrylate, a urethane (meth)acrylate, or combinations thereof.

4. The vinyl primer system of claim 3, wherein the second oligomer is present in the vinyl primer system in an amount less than 40% by weight.

5. The vinyl primer system of claim 2, wherein the polymerizable or cross-linkable compound is the second oligomer, wherein the second oligomer has different degrees of functionality of two or higher.

6. The vinyl primer system of claim 1, wherein the first oligomer has acrylate functionality which may be uniform or vary along the oligomer chain, and wherein the first oligomer has degrees of functionality of two or more.

7. The vinyl primer system of claim 1, wherein the ink-receptive coating is configured to have a thickness between 3 and 40 micrometers.

8. The vinyl primer system of claim 1, wherein the vinyl primer system contains 10 to 95% by weight of the combination of the first oligomer and any additional polymerizable or cross-linkable compounds if present.

9. The vinyl primer system of claim 1, further comprising 1 to 50% by weight of pigment.

10. The vinyl primer system of claim 1, further comprising 1 to 35% by weight of an extender.

11. The vinyl primer system of claim 1, further comprising additives such as defoamers, leveling agents, dispersing agents, anti-settling agents, and/or rheology modifiers.

12. The vinyl primer system of claim 1, wherein the viscosity of the vinyl primer system is between 200 and 1500 centipoise at 77 degrees Celsius.

13. A system comprising:
an ink-receptive primer coating;
an ink coating arranged over the ink-receptive primer coating; and
optionally one or more additional coatings arranged over the ink coating,
wherein at least one of the ink-receptive primer coating or a first additional coating of the one or more additional coatings comprises a vinyl primer system, the vinyl primer system comprising:
a first oligomer comprising at least one of polyether (meth)acrylate or modified polyether (meth)acrylate; and
a photoinitiator configured to cure at least the first oligomer upon exposure to a curing radiation,
wherein the vinyl primer system contains 10 to 95% by weight of a combination of the first oligomer and any additional polymerizable or cross-linkable compounds if present, and
wherein the system is configured to be arranged over a substrate.

14. The system of claim 13, wherein the curing radiation is UV light, LED light, electron beam, or a combination thereof.

15. The system of claim 13, wherein the ink-receptive primer coating comprises one or more layers, and wherein each layer of the ink-receptive primer coating has a dry film thickness of to 40 micrometers.

16. The system of claim 13, wherein the ink-receptive primer coating comprises at least one additional oligomer different than the first oligomer.

17. The system of claim 13, wherein the substrate is a synthetic vinyl floor, engineered wood, polymer composite, metal, wood, paper, or combinations thereof.

18. The system of claim 13, wherein the ink-receptive primer coating comprises a monomer diluent.

19. A method of coating a substrate comprising:
applying a primer composition on the substrate;
applying a digital ink to the primer composition;
optionally applying one or more additional coatings to the substrate and over the primer composition and digital ink; and
exposing the primer composition, the digital ink, and the one or more additional coatings to a curing radiation to form a cured coating system over the substrate,
wherein at least one of the primer composition or a first additional coating of the one or more additional coatings comprises:
a first oligomer comprising at least one of polyether (meth)acrylate or modified polyether (meth)acrylate; and
a photoinitiator.

20. The method of claim 19, wherein the primer composition comprises from 5 to 95% by weight of the first oligomer before curing.

21. The method of claim 19, wherein the primer composition contains 5 to 98% by weight of a combination of the first oligomer and any additional polymerizable or cross-linkable compounds if present.

22. The method of claim 19, wherein the primer composition is applied via roll coating or spraying.

23. The method of claim 19, wherein the at least one of the additional coatings and the primer composition both comprise the first oligomer and the photoinitiator.

24. The method of claim 19, wherein the curing radiation is UV light, LED light, electron beam, or combinations thereof.

25. The method of claim 19, wherein the at least one of the primer composition or the first additional coating contains less than 20% by weight of monofunctional (meth)acrylic-based monomers.
